(19) United States
(12) Patent Application Publication
(10) Pub. No.: US 2009/0090864 A1
(43) Pub. Date: Apr. 9, 2009

(54) Thermal imager having integrated support assembly

(76) Inventors: Tracy Glatzmaier, Soquel, CA (US); Thomas P. Haller, Soquel, CA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/906,764

(22) Filed: Oct. 3, 2007

(51) Int. Cl. G02F 1/01

(52) U.S. Cl. 250/330

(57) ABSTRACT

A thermal imaging apparatus has an integrated support assembly. The apparatus comprises a housing having a main housing portion containing a thermal image camera. A display for showing thermal images as detected by the camera is also provided. The housing further includes a handle attached to the main housing portion. The support assembly includes at least one support element selectively movable between a stored position and an extended position. The support element is adapted to facilitate support of the thermal imaging apparatus when the support element is in the extended position.

### BACKGROUND OF THE INVENTION

The present invention relates generally to thermal imagers. More particularly, the invention relates to a thermal imager having an integrated support assembly which maintains the imager in a stable position.

Thermal imaging cameras are widely used in a variety of applications, such as predictive maintenance in industrial facilities. In the past, such devices were often large, requiring the use of tripods or carts for mounting and transportation. More recently, lightweight, hand-held units have appeared in the marketplace.

While an operator will typically hold the smaller units during use, it is occasionally desirable to maintain the unit steady in a particular position. This can be accomplished using a traditional tripod stand. Typically, such tripods include three telescopic legs which fold together for storage. When it is desired to use the tripod, the legs are pivoted apart and extended to the desired length.

Traditional tripods have worked well, but they are often bulky and inconvenient. As a result, users will often choose not to bring a tripod with them to an inspection site. If situations requiring the use of a tripod subsequently arise, the user has no alternative except attempting to hold the unit as steady as possible. The results achieved with this approach are often less than satisfactory.

### SUMMARY OF THE INVENTION

According to one aspect, the present invention provides a thermal imaging apparatus comprising a housing having a main housing portion containing a thermal image camera. A display for showing thermal images as detected by the camera is also provided. The housing further includes a handle attached to the main housing portion. Also provided is a support assembly including at least one support element selectively movable between a stored position and an extended position. The support element is adapted to facilitate support of the thermal imaging apparatus when the support element is in the extended position.

Preferably, the at least one support element may be located at a distal end of the handle. In such embodiments, the support assembly may include a recess defined at the distal end of the handle such that the support element is located in the recess.

In some exemplary embodiments, a pair of support elements pivotable about a common pivot point may be provided. The support elements in such embodiments are pivoted together in the retracted position and pivoted apart in the extended position. Each of the support elements may comprise an elongate member having a substantially flat configuration. The support elements may be configured to nest with each other in the stored position.

In accordance with other embodiments, the at least one support element may comprise an elongate member pivotable about an axially intermediate pivot point. The elongate member may have a substantially flat configuration.

In accordance with other embodiments, the at least one support member may comprise a pair of struts functioning along with a base of the housing to form a tripod stand when the struts are in the extended position. Preferably, such struts may rotate about respective first and second pivot points. The struts may be located on respective sides of the housing such that they are received in a respective slot when in the stored position.

Other aspects of the invention are achieved by a hand-held thermal measurement apparatus comprising a housing having a main housing portion and a depending handle. A display is located on the housing for showing thermal information. The apparatus further includes a support assembly including a recess defined in a distal end of the handle. At least one support element is selectively movable between a stored position and an extended position. The support element is adapted to facilitate support of the thermal imaging apparatus when the support element is in the extended position.

Still further aspects of the invention are achieved by a hand-held thermal measurement apparatus comprising a housing having a main housing portion and a depending handle. A display is located on the housing for showing thermal information. The apparatus further includes a support assembly having a pair of struts functioning along with a base of the housing to form a tripod stand when said struts are in the extended position.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a rear perspective view of a thermal imager constructed in accordance with an embodiment of the present invention;

FIG. 2 is a front perspective view of the thermal imager of FIG. 1;

FIG. 3 is an enlarged fragmentary view of a bottom portion of the thermal imager of FIG. 1 showing a support assembly thereof;

FIG. 4 is a perspective view with the support assembly in an extended position;

FIG. 5 is a fragmentary exploded view showing the support assembly according to this embodiment;

FIG. 6 is a bottom view of a portion of the thermal imager of FIG. 1 showing the support assembly thereof;

FIG. 7 is a perspective view of a thermal imager including a support assembly constructed in accordance with a second embodiment of the present invention;

FIG. 8 is a bottom view of a portion of the thermal imager of FIG. 7 showing the support assembly thereof; and

FIG. 9 is a perspective view of a thermal imager including a support assembly constructed in accordance with a third embodiment of the present invention.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

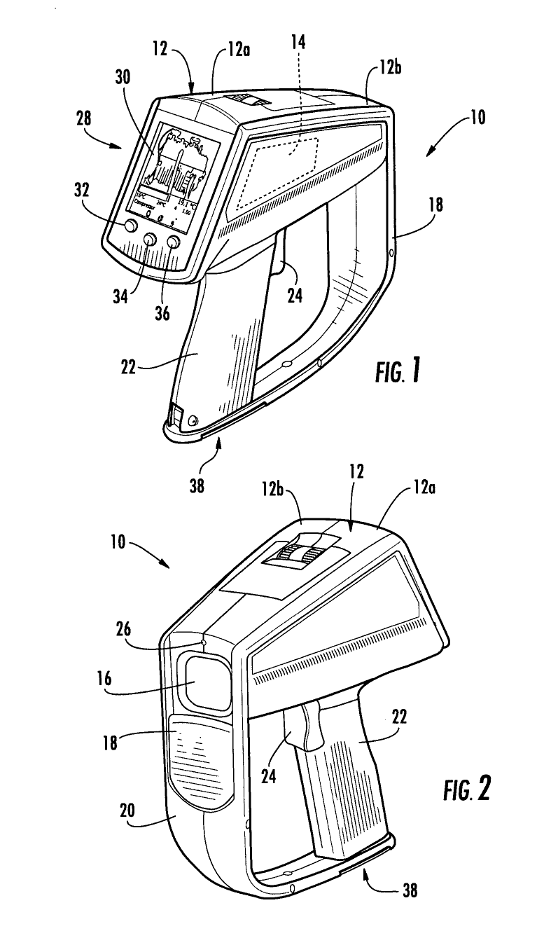

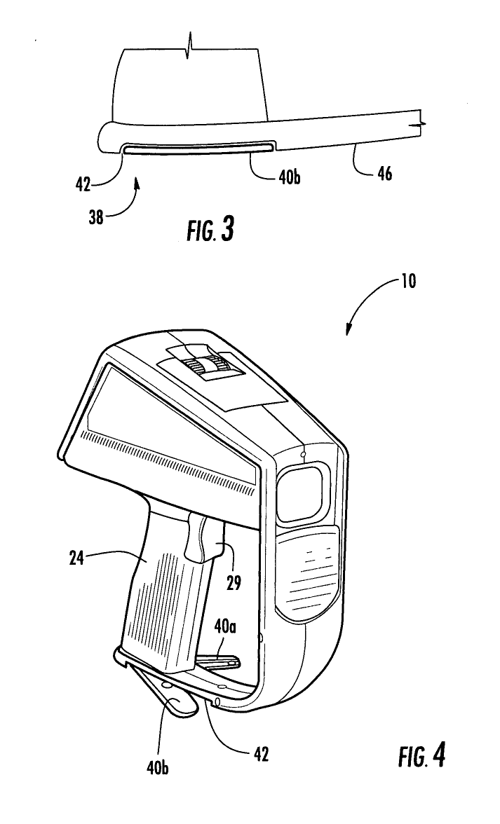

FIGS. 1 and 2 illustrate an exemplary hand-held thermal imager which utilizes principles of the present invention. As shown, thermal imager 10 includes a housing 12 in which the components of a thermal image camera 14 are located. In this example, housing 12 is formed by complementary left and right housing portions 12a and 12b which are joined together during assembly. While any suitable material can be utilized, housing portions 12a and 12b are preferably formed of a rigid high impact plastic material. Selected regions of housing 12 may be desirably overmolded with a softer polymeric material.

Housing 12 includes a front portion defining a hood 16 where the device's lens is located. As one skilled in the art will appreciate, the target energy enters the device through this lens. A lens cover 18 may be provided to cover the lens when imager 10 is not in use.

In this case, lens cover 18 slides up and down in a channel provided in a front shroud 20. Specifically, cover 18 is moved to the down position (shown) when imager 10 is in use. Cover 18 is moved to an up position in front of hood 16 when imager 10 is turned off. As shown, shroud 20 extends to a location under handle 22 to facilitate placement of the entire unit in a computer docking station for recharging and specialized programming.

A trigger 24 is located on handle 22, as shown. Trigger 24 permits the user to store selected images in the device's internal memory. In the illustrated embodiment, laser diode 26 projects a dot of light forward of the imager to facilitate aiming.

As indicated at 28, a display is preferably located at the rear of imager 10. In this case, a variety of thermal information is shown on the display, including a thermal image 30 of the device being inspected. A temperature gradient scale and other information may also be provided in different regions of the display. For example, the display may provide a numeric temperature reading of the object at the camera cross-hairs. Various functions of imager 10 are controlled by buttons 32, 34 and 36.

Thermal imager 10 further includes a support assembly 38 which functions to maintain imager 10 in a stable position on a surface, such as a table. As a result, support assembly 38 functions similar to a separate tripod without the necessity of the user carrying the tripod.

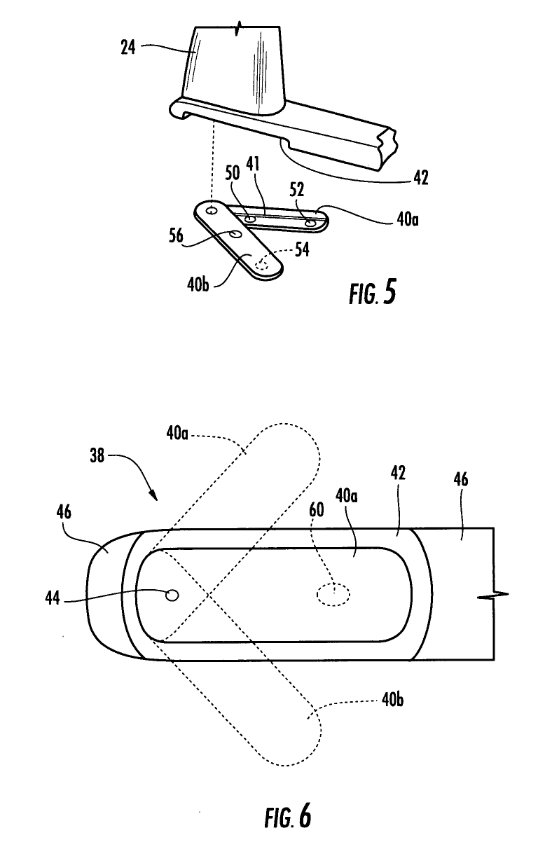

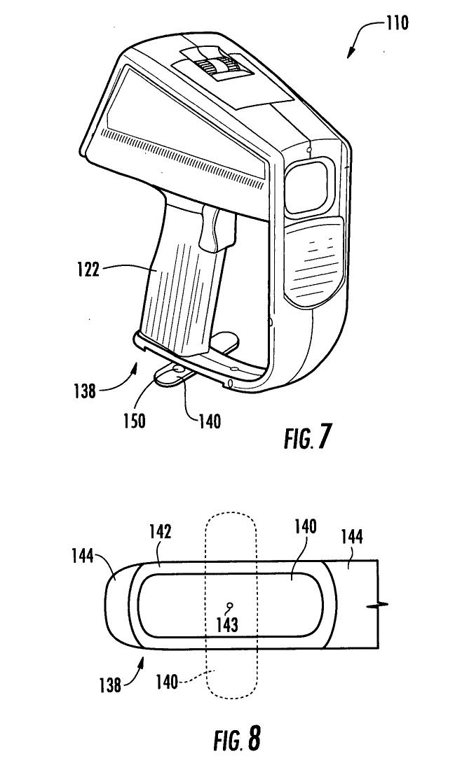

Referring now to FIGS. 3-6, support assembly 38 in this embodiment includes a pair of support elements 40a and 40b located in a recess 42 defined in the distal end of handle 24. As shown in solid lines in FIG. 6, support elements 40a and 40b are adapted to be maintained in a stored position when not in use. In this embodiment, elements 40a and 40b are configured as respective elongate members each having a substantially flat configuration. In addition, elements 40a and 40b may include opposing ledges (one of which can be seen at 41 in FIG. 5) so that the support elements will overlap and nest when in the stored position. As a result, support elements 40a and 40b will be contained in the stored position within the “footprint” of the imager.

In this embodiment, elements 40a and 40b pivot about a common pivot point 44. When it is desired to use support assembly 38, support elements 40a and 40b are thus pivoted apart such that they both extend to a position outside the “footprint” of imager 10. As a result, imager 10 may be stably supported on a surface. In particular, support elements 40a and 40b, as well as the base 46 of the imager housing, will together function to support the imager in an upright and stable position.

Preferably, support elements 40a and 40b will be appropriately spring loaded at pivot point 44 so they will be urged into the extended position when desired. In such embodiments, support elements 40a and 40b are thus closed into the stored position against the spring force. A suitable detent mechanism is preferably provided in order to maintain the support elements in the stored position.

In this case, for example, support element 40a includes a pair of raised features 50 and 52 on its top surface. Feature 50 is adapted to engage the edge of element 40b for detent in the deployed position. Feature 52 engages a socket (small recess) 54 formed on the underside of element 40b to create detent in the stored position.

In addition, support element 40b includes a raised feature 56 on its top surface. Feature 56 acts against the edge of base 46 for detent in the deployed position. Feature 56 also engages a socket 60 defined in base 46 for detent in the stored position.

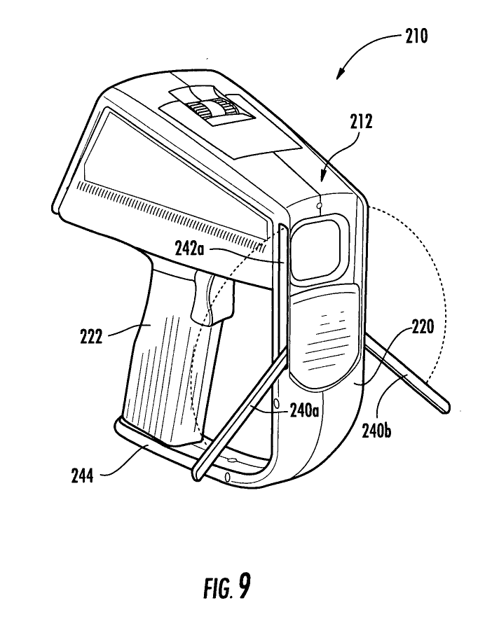

FIGS. 7 and 8 illustrate an alternative embodiment of the present invention. In this case, a thermal imager 110 includes a support assembly 138. Support assembly 138 includes a single support element 140 located in a recess 142 at the distal end of handle 122. In this embodiment, support element 140 is configured as an elongate member which pivots about an axially intermediate pivot point 143. As shown, element 140 is rotated between a stored position and an extended position (as shown in solid lines and broken lines, respectively, in FIG. 8).

When support element 140 is in the stored position, it will be contained within the “footprint” of imager 110. In the extended position, however, the respective ends of support element 140 will extend laterally beyond the imager's footprint in order to facilitate support of imager 110 on a surface. In other words, support element 140, along with base 144 of imager 110, will stably maintain thermal imager 110 in an upright position.

Preferably, a detent mechanism is provided to maintain support element 140 in either of the two positions. In this case, for example, the detent mechanism includes a raised feature 150 on the top surface of element 140. Feature 150 acts against the edge of base 144 to provide detent when deployed. In addition, feature 150 engages a socket defined in base 144 to act as a detent in the stored position. Element 140 is preferably spring loaded at pivot point 143 to provide compliance.

FIG. 9 illustrates a further embodiment of a thermal imager 210 constructed in accordance with the present invention. In this case, a pair of struts 240a and 240b are located on respective sides of housing 212. Although struts 240a and 240b are located in the shroud 220 in this embodiment, one skilled in the art will recognize that they can be situated in other locations on the housing. For example, embodiments are contemplated in which struts 240a and 240b are located on respective sides of handle 222.

Strut 240a is pivotable about a first pivot point located at its proximal end. Similarly, strut 240b is pivotable about a second pivot point located at its proximal end. When in the stored position, struts 240a and 240b are received in respective slots (such as slot 242a) located on respective sides of housing 212.

When it is desired to use the support assembly, struts 240a and 240b are rotated to the extended position. In the extended position, the distal ends (tips) of struts 240a and 240b will contact the surface on which imager 210 is to be supported. Thus, struts 240a and 240b, along with the base 244 of imager 210, form a tripod stand which stably maintains imager 210 in an upright position. A suitable latching mechanism is provided to maintain struts 240a and 240b in either the stored position or the extended position, as desired.

It can thus be seen that the present provides an imager device that advantageously utilizes a retractable support feature. One skilled in the art will appreciate that principles of the present invention are applicable to devices other than a thermal imager, such as a handheld noncontact thermometer. Thus, while preferred embodiments of the invention have been shown and described, modifications and variations may be made thereto by those of ordinary skill in the art without departing from the spirit and scope of the present invention. In addition, it should be understood that aspects of various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. A thermal imaging apparatus comprising:
a housing having a main housing portion containing a thermal image camera;
a display for showing thermal images as detected by said camera;
said housing including a handle attached to said main housing portion; and
a support assembly including at least one support element selectively movable between a stored position and an extended position, said support element being adapted to facilitate support of said thermal imaging apparatus when said support element is in said extended position.

2. An apparatus as set forth in claim 1, wherein said at least one support element is located at a distal end of said handle.

3. An apparatus as set forth in claim 2, wherein said support assembly includes a recess defined at said distal end of said handle, said support element being located in said recess.

4. An apparatus as set forth in claim 3, wherein said at least one support element comprises a pair of support elements pivotable about a common pivot point such that said support elements are pivoted together in said stored position and pivoted apart in said extended position.

5. An apparatus as set forth in claim 4, wherein each of said support elements comprises an elongate member having a substantially flat configuration.

6. An apparatus as set forth in claim 4, wherein said support elements are configured to nest with each other in said stored position.

7. An apparatus as set forth in claim 3, wherein said at least one support element comprises an elongate member pivotable about an axially intermediate pivot point.

8. An apparatus as set forth in claim 7, wherein said elongate member has a substantially flat configuration.

9. An apparatus as set forth in claim 1, wherein said at least one support member comprises a pair of struts functioning along with a base of said housing to form a tripod stand when said struts are in said extended position.

10. An apparatus as set forth in claim 9, wherein said struts rotate about respective first and second pivot points.

11. An apparatus as set forth in claim 9, wherein said struts are located on respective sides of said housing.

12. An apparatus as set forth in claim 10, wherein each of said struts is received in a respective slot when in said stored position.

13. A hand-held thermal measurement apparatus comprising:
a housing having a main housing portion and a depending handle;
a display located on said housing for showing thermal information;
a support assembly including:
a recess defined in a distal end of said handle; and
at least one support element selectively movable between a stored position and an extended position, said support element being adapted to facilitate support of said thermal imaging apparatus when said support element is in said extended position.

14. An apparatus as set forth in claim 13, wherein said at least one support element comprises a pair of support elements pivoted together in said retracted position and pivoted apart in said extended position.

15. An apparatus as set forth in claim 14, wherein each of said support elements comprises an elongate member having a substantially flat configuration.

16. An apparatus as set forth in claim 15, wherein said support elements are configured to nest with each other in said stored position.

17. An apparatus as set forth in claim 13, wherein said at least one support element comprises an elongate member pivotable about an axially intermediate pivot point.

18. An apparatus as set forth in claim 17, wherein said elongate member has a substantially flat configuration.

19. A hand-held thermal measurement apparatus comprising:
a housing having a main housing portion and a depending handle;
a display located on said housing for showing thermal information;
a support assembly including a pair of struts functioning along with a base of said housing to form a tripod stand when said struts are in said extended position.

20. An apparatus as set forth in claim 19, wherein said struts rotate about respective first and second pivot points.

21. An apparatus as set forth in claim 19, wherein said struts are located on respective sides of said housing.

22. An apparatus as set forth in claim 20, wherein each of said struts is received in a respective slot when in said stored position.
